(19) United States
(12) Patent Application Publication
(10) Pub. No.: US 2024/0186518 A1
(43) Pub. Date: Jun. 6, 2024

(54) BINDER COMPOSITION FOR NEGATIVE ELECTRODE

(71) Applicant: Arkema Inc., King of Prussia, PA (US)

(72) Inventors: Jinbao CAO, King of Prussia, PA (US); Wenjun WU, King of Prussia, PA (US); Ramin AMIN-SANAYEI, King of Prussia, PA (US); Brian T. KOO, King of Prussia, PA (US); Jean-Marc SUAU, Lucenay (FR); Marine DUVER, Villeurbanne (FR)

(21) Appl. No.: 18/284,888

(22) PCT Filed: May 12, 2022
(86) PCT No.: PCT/US2022/028904

§ 371 Date: Sep. 29, 2023

Related U.S. Application Data
(60) Provisional application No. 63/188,513, filed on May 14, 2021.

(51) Int. Cl. H01M 4/62; H01M 4/02; H01M 4/04; H01M 4/583

(52) U.S. Cl. CPC H01M 4/622; H01M 4/0404; H01M 4/583; H01M 2004/021; H01M 2004/027

(57) ABSTRACT

An electrode forming composition for use as the active material layer on a current collector of an electrode within a non-aqueous electrical energy storage device is provided. The electrode forming composition includes a) at least one particulate electrode-forming material, b) a polymeric binder. The polymeric binger includes at least one non-ionic monoethylenically unsaturated monomer and at least one particular oxyalkylated monomer with ethylenic unsaturation and terminated by hydrogen or an aryl or alkyl chain.

### FIELD OF THE INVENTION

The invention relates to an electrode forming composition useful for forming negative electrodes for use in electrochemical electrical energy storage devices and secondary batteries.

### BACKGROUND

There has been increasing interest in light weight and high energy density secondary (rechargeable) battery technology. Lithium-ion batteries (LIB) have been used widely as the power source for many devices, such as consumer electronics, electric vehicles, and power tools. The growing popularity of zero-emission electric vehicles, particularly long-range electric vehicles, demands LIB technology with further improved energy density, and durability. To improve battery energy density and overall performance, different components of a battery are being investigated. These components include the negative electrode (anode), the positive electrode, the electrolyte and the separator. Improved negative electrodes have great potential to boost battery energy density, in particular, if improved binders are used for the anode.

Water-based slurries are often preferred over solvent-based slurries in fabrication of the electrodes of such secondary batteries due to environmental concerns. Typically, these electrodes are manufactured by dispersing the electrode-forming ingredients in water, casting the slurry or paste on the current collector as a thin film and then allowing the film to dry to form the electrode. The function of the polymeric binder is to bind the electrode-forming particulates together onto the current collector. The electrode-forming particulates of the negative electrode (anode) for these secondary lithium ion batteries typically includes an active material (e.g. carbonaceous material) that can reversibly absorb and release or host (intercalate) lithium ions to create reaction sites for lithium ion electrochemical reactions (battery charging/discharging), a conductive additive, a rheology modifier and a polymeric binder. The anode active material is a substance that can donate or accept electrons during the charging/discharging cycle. The conductive additive is typically used to improve the conductivity of the negative electrode (anode), which reduces the battery's internal resistance, and consequently boosts power output of the battery. A rheology modifier is typically present in the anode slurry formulation to adjust the slurry rheology for the electrode manufacturing casting process. Examples of rheology modifiers used in negative electrode formulations include carboxymethylcellulose (CMC) and polyacrylic acid (PAA). The function of the polymeric binder is to bind the anode components together onto the current collector. Styrene-butadiene rubber (SBR) latex generally is a dominant anode binder.

It has been reported [K. Hays et al; J. Phys. Chem. C 2018, 122, 18, 9746-9754] that amorphous silicon (Si) can be oxidized and generate H₂ gas during aqueous slurry preparation for lithium ion battery application. The use of Si in secondary batteries is important because it may have the possibility to increase the energy density of Li ion battery anodes. However, H₂ generation imposes a safety concern during large-scale battery fabrication.

The ongoing industrial trend to improve the battery energy density and the advancement of anode active material presents new challenges for those traditional polymeric binders A need remains for an anode binder that provides a secondary battery having high energy density, no H₂ generation and excellent service life. Binders that provide functional benefits to the anode in addition to simply physically holding the active and conductive materials together and providing physical flexibility are needed.

In Sci. Rep. 2020, 14966, titled “A conductive self healing polymeric binder using hydrogen bonding for Si anodes in lithium ion batteries,” ethylene oxide-containing monomer was copolymerized with other polymerizable monomers to prepare a polymer for a battery anode binder application. The polymerization method for preparing the polymer was solution phase polymerization, using organic solvent (e.g. dimethylformamide).

In Adv. Energy Mater. 2018, 1703138, titled “Ionically Conductive Self-Healing Binder for Low Cost Si Microparticles Anodes in Li-Ion Batteries,” polyethylene glycol containing reactive isocyanate functional was grafted onto a polymer side chain to generate ethylene oxide containing polymer for battery anode binder application.

In Adv. Funct. Mater. 2019, 1908558, titled “Re-Engineering Poly(Acrylic Acid) Binder toward Optimized Electrochemical Performance for Silicon Lithium-Ion Batteries: Branching Architecture Leads to Balanced Properties of Polymeric Binders,” ethylene oxide containing monomer [tetra(ethylene glycol) diacrylate] was copolymerized with acrylic acid to prepare a polymer for anode binder application. An ethylene oxide-containing monomer with two reactive groups was used as the branching agent to generate a branched polymer.

In a dissertation titled “An Adhesive Vinyl-Acrylic Electrolyte and Electrode Binder for Lithium Batteries” by Binh Tran from University of Central Florida, poly(ethylene glycol) methyl ether methacrylate containing ethylene oxide was copolymerized with other polymerizable monomers to prepare a copolymer in organic solvent solution (e.g. ethyl acetate) via solution polymerization.

U.S. Pat. No. 8,790,622 discloses formulations containing one or more comb structure amphiphilic copolymers that are both rich in hydrophobic monomers and in polyalkylene glycol monomers.

U.S. Pat. No. 9,834,698 discloses latex binders useful for preparing zero or low VOC coating compositions obtained using a polymerizable polyalkylene glycol monomer such as polyethylene glycol methacrylate in combination with one or both of an emulsifier or a polymerizable polyalkylene glycol monomer containing bulky hydrophobic groups substituted on an aromatic ring.

A new electrode forming composition for use on a current collector of an electrode within a non-aqueous secondary electrical energy storage device that has high energy density and excellent service life performance of the secondary batter is desired. In the present invention, it was surprisingly found that the disclosed polymers which include certain functional groups may be used binders in electrode formulations to provide an electrode with low resistivity, good adhesion to the current collector, and low VOC content. In particular, the inventors discovered that the disclosed electrode forming compositions including polymeric binders having oxyalkylated functional groups are particularly useful as binders for active material layers on an anode for a secondary battery.

Unexpectedly and in addition, binders of this invention may prevent generation of H₂ gas during preparation of amorphous Si-containing water-borne slurries. This is an advantage for a large-scale anode production where large amounts of hydrogen may be produced.

### SUMMARY

The present invention is directed to electrode forming compositions for use on a current collector of an electrode within a non-aqueous electrical energy storage device. The electrode forming composition comprises, consists of, or consists essentially of a) at least one particulate electrode-forming material, b) a polymeric binder, and c) from 0-40% by weight of the polymeric binder of at least one crosslinking agent capable of reacting with the polymeric binder b).

The polymeric binder b) comprises, consists of, or consists essentially of the following, as polymerized monomers:
i) 10-99% by weight of the polymeric binder comprising, consisting of, or consisting essentially of at least one non-ionic monoethylenically unsaturated monomer;
ii) 0.5-42% by weight of the polymeric binder comprising, consisting of, or consisting essentially of at least one oxyalkylated monomer with ethylenic unsaturation and terminated by hydrogen or a aryl or alkyl chain (which may be hydrophobic), having the following formula:

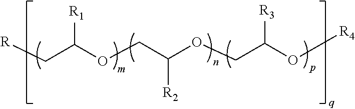

wherein:
m, n and p represent a number of alkylene oxide units of between 0 and 150, wherein m+n+p≥1,
q represents a whole number at least equal to 1, and preferentially such that 3≤(m+n+p)q≤150,
R₁, R₂, and R₃ represent either H, CH₃ or CH₂CH₃, and R₁, R₂, and R₃ can be the same or different,
R₄ represents a terminal group, which can be a hydrogen, alkyl chain with 1-60 carbon atoms or aryl chain with 5-60 carbon atoms,
R represents a group comprises, consists of, or consists essentially of at least one polymerizable olefinic unsaturation, preferably a group chosen from at least one of acrylate, methacrylate, acrylurethane, methacrylurethane, vinyl, allyl, methallyl, isoprenyl, an unsaturated urethane group, in particular acrylurethane, methacrylurethane, α-α′-dimethyl-isopropenyl-benzylurethane, allylurethane, more preferably a group chosen from at least one of acrylate, methacrylate, acrylurethane, methacrylurethane, vinyl, allyl, methallyl and isoprenyl, esters of maleic acid, esters of itaconic acid, esters of crotonic acid, even more preferably a methacrylate group, and mixtures thereof,
iii) 0-50% by weight of the polymeric binder comprises, consists of, or consists essentially of at least one ethylenically unsaturated ionic monomer comprises, consists of, or consists essentially of at least one functional group selected from at least one of carboxylate, sulfonate, sulfate, phosphate, phosphonate, and/or acid, and/or salt, and/or anhydride forms thereof,
iv) 0-10% by weight of the polymeric binder comprises, consists of, or consists essentially of at least one monomer comprising, consisting of or consisting essentially of at least two ethylenic unsaturations;
v) 0-10% by weight of the polymeric binder comprises, consists of, or consists essentially of at least one ethylenically unsaturated monomer comprising, consisting of, or consisting essentially of at least one functional group that may promote post-polymerization crosslink reactions. The at least one functional group may be selected from at least one of N-methylol amide, N-alkylol amide, hydroxyl group, epoxy, silane and keto;
vi) 0-30% by weight of the polymeric binder comprises, consists of, or consists essentially of at least one ethylenically unsaturated monomer comprising at least one functional group that may promote adhesion, which may be selected from silane, ureido, amine, hydroxyl group, and combinations thereof.

The total of components b) i) through b) vi) add up to 100% by weight of polymeric binder b).

The polymeric binder b) may have a Tg of 55° C. or less and/or a minimum film forming temperature of 25° C. or less.

The composition may also comprise, consist of, or consist essentially of the following optional components:
c) from 0-40% by weight of the polymeric binder of at least one crosslinking agent capable of reacting with the polymeric binder b);
d) from 0-10% by weight of the polymeric binder of one or more wetting agents;
e) 0-10% by weight of the polymeric binder of one or more dispersing agents;
f) 0-10% by weight of the polymeric binder of one or more VOC, and/or adhesion promoters, and/or coalescent agents;
g) 0-200% by weight of polymeric binder of one or more rheology modifier additives;
h) 0-10% by weight of polymeric binder of one or more additives comprising, consisting of, or consisting essentially of at least one of anti-setting agents, surfactants, and mixtures thereof.

The electrode forming composition as disclosed herein is typically prepared as a slurry, although it may be in the form of a solution, a dispersion, or a paste. Forming the electrode may therefore be done by applying a layer of the electrode forming slurry composition to the current collector. The conductive layer is then dried, to form the layer of electrode material, i.e. the active material layer, which is adhered to the current collector.

### DETAILED DESCRIPTION

The binder(s) of the invention provide a matrix for the particulate electrode-forming materials, which typically include an active material and a conductive material. The disclosed polymeric binders contain oxyalkylated monomer(s) in combination with other functional monomers, which together may improve the performance of the polymeric binder in the negative electrode.

As used herein, the term “electrode” refers to the dried layer of the electrode-forming slurry composition that is cast onto the current collector. Typically, electrodes are manufactured by casting the slurry or paste of dispersed electrode-forming ingredients and binder(s) as a thin film and then allowing the film to dry to form an electrode. This dried film is referred to as the electrode.

As used herein, the term “electrode assembly” is the combination of the current collector and the dried electrode that is dried thereon. The slurry or paste of dispersed electrode-forming ingredients and binder(s) can be cast onto a current collector such as a copper or nickel foil to form the electrode assembly. The electrode assembly can be further coated with a separator-forming slurry such as alumina and binder dispersed in water. The separator slurry can be cast simultaneously with the electrode slurry in a one-step process using a dual or a multi-die in a wet-on-wet process. Alternatively, after the electrode is dried, the separator slurry may be cast onto the electrode, or a free standing separator can be adhered onto the electrode surface. The electrode assembly therefore includes the current collector, the dried electrode film, and optionally a separator film on the top surface of the electrode.

As used herein, the term “slurry” means a free-flowing or flowable and/or pumpable suspension including fine solid materials and binder in water. Such fine solids may include, inter alia, polymeric binder particles, in addition to the solid particles that are usually the electrochemically active material(s) and conductive materials(s) necessary to form the electrode for a secondary battery. Additives may also be dissolved in the water, such as dispersing agents used to improve the quality of the dispersion of the fine solid material. The composition for use as an electrode can be deposited on the current collector by any method known in the art. Non-limiting examples of such application methods include spraying, rolling, draw bar application, bird bar application, gravure, slot coating, or other coil coating methods. The composition is dried, optionally with heat. The coating of the electrode forming composition may be optionally calendered before or after the drying step, to remove water and any other volatile materials. The drying times, temperatures, and any vacuum used can be adjusted to achieve the desired drying.

The current collector is a substance that collects and transports electrons during battery charging/discharging cycles. The selection of the current collector is not limited as long as it is electroconductive. Any common anode or cathode current collector used in secondary batteries can be used in the present invention. Non-limiting examples of the current collector may include copper, iron, aluminum, nickel, titanium, and gold. The current collector may be in the structural form of a mesh, a foam, a foil, a rod, or another morphology that does not interfere with current collector function. Current collector materials vary depending on whether an electrode is a positive electrode or a negative electrode. The most common current collectors for a negative electrode are sheets or foils of copper (Cu⁰) or nickel (Ni⁰) metal. The electrode material is applied to and must adhere to the surface of the current collector of the secondary battery, which is preferably a lithium ion battery.

### Particulate Electrode-Forming Material a)

The particulate electrode-forming material a) comprises particulate active materials and conductive particles held together (physically and/or chemically) by the polymeric binder b). Active materials are materials that are capable of intercalating lithium ions, i.e., are able to absorb/release lithium ions. Such active materials are known in the art. Conductive particles are also known in the art and are materials capable of conducting electrons. Certain materials are capable of performing both functions in an electrode.

The particulate electrode-forming materials may include but are not limited to a conductive carbon additive, carbon nanotubes (CNTs), synthetic graphite, natural graphite, hard carbon, activated carbon, carbon black, graphene, mesoporous carbon, amorphous silicon, semi-crystalline silicon, silicon oxides, silicon nanowires, tin, tin oxides, germanium, lithium titanate, mixtures or composites of the aforementioned materials, and/or other materials known in the art or described herein as suitable for use as the anode in a lithium ion battery. These particulates may include active materials, i.e., materials capable of intercalating (accepting) lithium ions, and conductive materials. The electrode film of a lithium ion capacitor and/or a lithium ion battery can include about 80 weight percent, preferably up to 94, and more preferably up to 98 weight percent of the particulate anode-forming materials, after drying. These electrode forming materials a) are typically in the form of solid powders.

Conductive carbon materials such as carbon black and graphite powders are widely used in positive and negative electrodes to decrease the inner electrical resistance of an electrochemical system. Non-limiting examples of conductive carbon may include furnace black, acetylene black, CNT, fine graphite powder, vapor deposited graphite fibers, and Ketjen carbon black. The typical loading level of the conductive carbon relative to the active material in the electrode forming materials a) is usually within the range of 0.1% by weight to 20% by weight, and more preferably within the range of 0.5% by weight to 10% by weight of the total amount of the particulate anode-forming materials.

The amount of the particulate anode-forming materials a) (including both the active material and the conductive carbon present in the electrode forming composition, may be from 50 wt % to 99 wt % of the total dried weight of the composition, preferably from 80 to 98 wt % and most preferably from 94 to 98 wt % of the total dried weight of the composition.

### Polymeric Binder b)

The electrode forming slurry composition further comprises, consists of, or consists essentially of polymeric binder b). The polymeric binder b) is present in the active material layer. One function of the binder b) is to bind together (chemically or physically) particulate anode forming materials a) to form the electrode. The polymeric binder b) may be in the form of polymeric particles. These polymeric particles may be provided in the form of an emulsion or latex.

The inventors surprisingly found that preferably, the Tg of the disclosed polymeric binder b) should be within a certain range. The Tg is the temperature below which the physical properties of polymers change from thermoplastic (e.g. flexible, soft, stretchable) to those of the glassy state which limits flexibility and elongation of the polymeric binder b). As a result, upon bending of electrode, cracks (visible or micro-cracks) can form in electrodes which in turn deteriorate electrode performance. For ease of electrode handling and good electrode performance, the Tg of the polymeric binder b) may be at or about or preferably below room temperature, i.e. preferably below 55° C., more preferably below 45° C., even more preferably below 35° C., most preferably below 25° C., below 20° C., or below 10° C., according to certain embodiments.

Without intending to be bound by any theory, in order to have a satisfactory electrode integrity using the electrode forming composition (which may be in the form of a waterborne slurry) disclosed herein, as the aqueous phase evaporates, the polymeric binder b) latex particles coalesce into a continuous network which can hold (chemically or physically) the active materials and conductive carbon in an interconnected electrode network. The minimum film formation temperature (MFFT) of the polymeric binder b) latex particles is the minimum temperature where the coalescence of the polymeric particles occurs as the water evaporates to form continuous films. The MFFT is defined as the minimum temperature at which the polymer binder b) latex particles coalesce to form a continuous film. The polymeric binder b) latex particles advantageously have an MFFT at about or below room temperature, i.e., below preferably 55° C., more preferably below 50° C., below 45° C., still more preferably below 35° C., most preferably below 25° C., or below 20° C., according to certain embodiments.

There is little or no need for adding coalescents that contribute to the volatile organic content or volatile organic compounds (VOC) of the electrode forming slurry composition of this invention. In an embodiment, the electrode forming composition has a VOC content of from 0 to less than 5 wt %, in another embodiment from 0 to less than 1 wt %, and in still another embodiment from 0 to less than 0.1 wt % by weight of the composition.

As discussed in more detail below, the polymeric binder b) comprises, consists of or consists essentially of, as polymerized monomers, a number of particular monomers. The selection of polymerization method for the disclosed polymeric binder b) is not particularly limited. Any polymerization method can be used to synthesize the disclosed binder. Non-limiting examples of polymerization methods may include solution polymerization, emulsion polymerization, bulk polymerization, and suspension polymerization, free radical polymerization, controlled polymerization, and ionic polymerization. In one preferred embodiment, the polymeric binder b) is prepared through free radical polymerization via emulsion polymerization.

The number average molecular weight of the disclosed binder is preferably 1000 g/mol or more, and more preferably 5000 g/mol or more, and even more preferably 10,000 g/mol or more. As used herein, number average molecular weights are determined by gel permeation chromatography, using polystyrene standards.

The polymeric binder b) may have a volume average particle size of from 30-500 nm, or can be a mix of various particle sizes from 30-500 nm. The particle size is preferably within the range of 30-400 nm, and more preferably within the range of 40-350 nm, and even more preferably within the range of 50-300 nm. As used herein, particle sizes are determined by dynamic light scattering (DLS).

The loading of the polymeric binder b) in the composition relative to the electrode forming materials a) is preferably 1% by weight or more binder b), more preferably 2% by weight or more binder b), and preferably 30% by weight or less, more preferably 20% by weight or less binder b) relative to weight of the electrode forming materials a). When the loading of the polymeric binder b) is within the aforementioned range, it can provide good binding performance.

The monomers included in the polymeric binder b) are described in more detail below.

### Non-Ionic Monoethylenically Unsaturated Monomer i)

The disclosed polymeric binder b) may contain one or more non-ionic monoethylenically unsaturated monomers i). The selection of the non-ionic monoethylenically unsaturated monomer i) is not particularly limited. Non-limiting examples include acrylic and methacrylic acid esters, such as C1 to C12 alkyl (meth)acrylates, styrene and derivatives thereof, vinyl acetate, vinyl versatate, (meth)acrylamide, (meth)acrylonitrile and derivatives thereof, diisobutylene, vinylpyrrolidone, vinylcaprolactam and mixtures thereof. Non-ionic monomers i) that provide corresponding low Tg polymers are preferred for the disclosed polymeric binder b). For example, ethyl acrylate, butyl acrylate, 2-ethylhexyl acrylate are preferred for monomer i). The weight percentage of the non-ionic monoethylenically unsaturated monomer i) in the disclosed polymeric binder b) is preferably within the range of 10 to 99 wt % by weight, and more preferably within the range of 20 to 95 wt % by weight, and particularly preferably within the range of 30 to 90 wt % by weight of the polymeric binder b).

Oxyalkylated Monomers with Ethylenic Unsaturation and Terminated by Hydrogen or a Aryl or Alkyl Chain ii)

The polymeric binder b) comprises, consists of, or consists essentially of various oxyalkylated monomers ii) with ethylenic unsaturation and terminated by hydrogen or an aryl chain with 5-60 carbon atoms or an alkyl chain with 1 to 60 carbon atoms (which may be hydrophobic), where oxyalkylated monomer ii) is represented by the following formula:

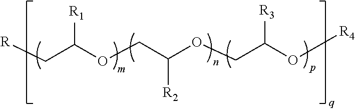

wherein:
m, n and p represent a number of alkylene oxide units of between 0 and 150, wherein m+n+p≥1,
q represents a whole number at least equal to 1, and preferentially such that 3≤(m+n+p)q≤150,
R₁, R₂, and R₃ represent either H, CH₃ or CH₂CH₃, and R₁, R₂, and R₃ can be the same or different,
R₄ represents a terminal group, which can be a hydrogen, alkyl chain with 1-60 carbon atoms or aryl chain with 5-60 carbon atoms,
R represents a group comprising, consisting of or consisting essentially of at least one polymerizable olefinic unsaturation, preferably a group chosen from at least one of acrylate, methacrylate, acrylurethane, methacrylurethane, vinyl, allyl, methallyl, isoprenyl, an unsaturated urethane group, in particular acrylurethane, methacrylurethane, α-α′-dimethyl-isopropenyl-benzylurethane, allylurethane, more preferably a group chosen from at least one of acrylate, methacrylate, acrylurethane, methacrylurethane, vinyl, allyl, methallyl and isoprenyl, esters of maleic acid, esters of itaconic acid, esters of crotonic acid, even more preferably a methacrylate group, and mixtures thereof.

Non-limiting examples of monomers ii) comprising these functional groups include polyalkylene glycol mono(meth)acrylate and its hydroxyl group functionalized derivatives, polyalkylene glycol monoallyl ether and its hydroxyl group functionalized derivatives, polyalkylene glycol monovinyl ether and its hydroxyl group functionalized derivatives, and combinations thereof. These functional monomers ii) may be used alone or in combination.

At least one oxyalkylated monomer ii) is present in the polymeric binder b) at from 0.5 wt % to 42 wt % by weight of the total polymeric binder b). The weight percentage of the oxyalkylated functional monomers ii) in the polymeric binder b) preferably should be within the range of 0.5 to 42 wt %, and more preferably within the range of 1 to 30 wt %, and even more preferably within the range of 1.5 to 20 wt % by weight of the polymeric binder b).

Ethylenically Unsaturated Ionic Monomer Including at Least One Functional Gr-Pp Selected from at Least One of Carboxylate, Sulfonate, Sulfate, Phosphate, Phosphonate, and/or Acid and/or Salt, and/or Anhydride Forms Thereof iii)

The polymeric binder b) may contain monoethylenically unsaturated ionic monomer iii). The weight percentage of the monoethylenically unsaturated ionic monomer iii) in the disclosed polymeric binder b) is preferably within the range of 0-50% by weight, and more preferably within the range of 5-40% by weight, and even more preferably within the range of 10-30% by weight of the polymeric binder b).

The selection of the monoethylenically unsaturated ionic monomer iii) is not particularly limited. It may be selected from monoethylenically unsaturated monomers comprising at least one functional group selected from at least one of carboxylate, sulfonate, sulfate, phosphate, phosphonate, and/or acid and/or salt, and/or anhydride forms thereof. Non-limiting examples may include (meth)acrylic acid, 2-carboxyethyl acrylate, 2-polycarboxyethyl acrylate, mono-esters of itaconic acid, maleic acid, fumaric acid, crotonic acid, itaconic acid, 2-acrylamide-2-methylpropane sulfonic acid, 4-styrenesulfonic acid, vinylsulfonic acid, 2-sulfoethyl methacrylate, phosphate esters of polyalkylene glycol mono(meth)acrylate, polyalkylene glycol allyl ether phosphates, vinylphosphonic acid, 2-(methacryloyloxy)ethyl phosphonic acid, in acid forms, and/or salt forms, and/or anhydride forms thereof (if chemically possible), and mixtures thereof.

The disclosed polymeric binder b) optionally containing ionic functional groups iii) and the hydrophilic functional oxyalkylated monomer ii) may have increased viscosity upon neutralization treatment in aqueous solution. Hence, the disclosed polymeric binder b) may function as a self-thickening binder in an anode slurry. The self-thickening polymeric binder b) may be used with or without a traditional rheology modifier, e.g. carboxy methyl cellulose (CMC) in anode or cathode slurry formulation.

### Monomers Including at Least Two Ethylenic Unsaturations iv)

The polymeric binder b) may also comprise, consist of or consist essentially of at least one monomer including at least two ethylenic unsaturations iv). These monomers comprising at least two ethylenic unsaturations iv) are capable of in-situ crosslinking of the polymeric binder b) during polymerization. Non-limiting examples of these monomers iv) are allylic ethers obtained from polyols; preferably allylic ethers obtained from polyols and selected from at least one of pentaerythritol, sorbitol, or sucrose; acrylic or methacrylic esters obtained from polyols, preferably acrylic or methacrylic esters obtained from polyols and selected from at least one of pentaerythritol, sorbitol, or sucrose; divinyl naphthalene, trivinylbenzene, 1,2,4-trivinylcyclohexane, triallyl pentaerythritol, diallyl pentaerythritol, diallyl sucrose, trimethylolpropane diallyl ether, 1,6-hexanediol di(meth)acrylate, allyl (meth)acrylate, diallyl itaconate, diallyl fumarate, diallyl maleate, butanediol dimethacrylate, ethylene di(meth)acrylate, poly(ethylene glycol) di(meth)acrylate, trimethylolpropane tri(meth)acrylate, methylenebis(meth)acrylamide, triallylcyanurates, diallyl phthalate, divinylbenzene and mixtures thereof. More preferred monomers iv) may be selected from at least one of 1,6-hexanediol di(meth)acrylate, allyl (meth)acrylate, ethylene di(meth)acrylate, poly(ethylene glycol) di(meth)acrylate, trimethylolpropane tri(meth)acrylate, diallyl phthalate, divinylbenzene and mixtures thereof. Even more preferred monomers iv) may be selected from at least one of 1,6-hexanediol di(meth)acrylate, allyl (meth)acrylate, poly(ethylene glycol) di(meth)acrylate, diallyl phthalate, divinylbenzene, and mixtures thereof.

The crosslinkable monomers iv) may be present in the polymeric binder b) at from 0-10% by weight of the polymeric binder b). The crosslinkable monomers iv) are preferably present at from 0.01% to 7%, more preferably at from 0.1 to 5%, and most preferably at from 0.1% to 1% by weight of the polymeric binder b).

### Ethylenically Unsaturated Monomer Including Functional Groups v)

The disclosed polymeric binder b) may further comprise, consist of or consist essentially of one or more crosslinkable monomers v) that comprise functional groups that may enable post-polymerization crosslink reactions (including optionally to enable monomer to be incorporated into the polymeric binder backbone). These ethylenically unsaturated functional monomers v) comprise, consist of or consist essentially of at least one reactive group in addition to the ethylenic unsaturation. The reactive groups can be the same or different if more than one is present. Suitable functional groups may be selected from at least one of N-methylol amide, N-alkylol amide, hydroxyl group, epoxy, silane, and keto groups. The selection of the ethylenically unsaturated monomer v) is not limited. Non-limiting examples of the ethylenically unsaturated monomers v) include at least one of N-methylol(meth)acrylamide, vinyl glycidyl ether, allyl glycidyl ether, glycidyl (meth)acrylate, diacetone acrylamide, acetoaetoxyethyl methacrylate, (meth)acryloxyalkyltrialkoxysilanes, vinyltrialkoxysilanes, and mixtures thereof.

The weight percentage of the monomer v) in the polymeric binder b) is preferably within the range of 0-10% by weight, and more preferably within the range of 0.05-7.5% by weight, and even more preferably within the range of 0.1-5% by weight of the polymeric binder b).

### Ethylenically Unsaturated Monomer Including Functional Groups vi)

The polymeric binder b) may further comprise, consist of or consist essentially of one or more ethylenically unsaturated monomers vi) that comprise functional groups. The functional groups in the monomer vi) may be selected from at least one of silane, ureido, amine, hydroxyl group, and combinations thereof.

The selection of monomers vi) is not limited. Non-limiting examples of monomers vi) comprise (meth)acryloxyalkyltrialkoxysilanes, vinyltrialkoxysilanes, (meth)acrylate ester of substituted urea, (meth)acrylamide of substituted urea, allyl ether of substituted urea, aminoalkyl (meth)acrylate, hydroxyalkyl (meth)acrylate. These functional ethylenically unsaturated monomers vi) may be optionally used alone or in combination to improve the polymeric binder b)'s performance in the electrode.

According to an embodiment, monomers vi) may be selected from at least one of (meth)acryloxyalkyltrialkoxysilanes, vinyltrialkoxysilanes, (meth)acrylate ester of substituted urea, (meth)acrylamide of substituted urea, allyl ether of substituted urea, aminoalkyl (meth)acrylate, hydroxyalkyl (meth)acrylate, and mixtures thereof.

According to a preferred embodiment, monomers vi) may be selected from at least one of (meth)acryloxyalkyltrialkoxysilanes, vinyltrialkoxysilanes, aminoalkyl (meth)acrylate, hydroxyalkyl (meth)acrylate, and mixtures thereof.

The weight percentage of the ethylenically unsaturated monomer vi) in the polymeric binder b) is preferably within the range of 0-30%, preferably the range of 0.01-10% by weight, and more preferably within the range of 0.05-7.5% by weight, and even more preferably within the range of 0.1-5% by weight of the polymeric binder b).

Notably, the monomers vi) may include silane or hydroxyl groups, as may some of the monomers v). Thus, where monomers v) and vi) both include one or more of silane and hydroxyl groups, there may be up to 40 wt % of a monomer including a silane or a hydroxyl group in the polymeric binder b).

### Crosslinking Agent c)

The disclosed composition may also include an optional crosslinking agent c). The crosslinking agent c) may react with functional groups of the disclosed polymeric binder b). For example, the post-crosslinkable functionalities in monomer v) may be crosslinked with or without external agents. Some of the post-crosslinkable functionalities may react with themselves to crosslink. Some of the post-crosslinkable functionalities in v) may require external agents to react with to form a crosslink. The crosslinking agent c) referred to herein is a component separate from the polymeric binder b) that is capable of reacting with some of the functionalities in the polymeric binder b). The crosslinking agent c) may be added to the polymeric binder b) during binder preparation. The crosslinking agent c) can also be added to the negative electrode slurry during electrode manufacturing as a two pack binder composition. The selection of the crosslinking agent c) is not particularly limited. Any crosslinking agent c) that has two or more functional groups that can react with the polymeric binder b) or the materials present in the negative electrode may be used as a crosslinking agent c). Non-limiting examples of the reactive functional groups within the crosslinking agent c) comprise, consist of or consist essentially of silane, epoxy, amine, alcohol, blocked isocyanate, aziridine, and carbodiimide. Suitable crosslinking agents c) may include but are not limited to alkoxysilanes, alkoxysilane derivatives, dihydrazides, polyfunctional hydrazides, diamines, polyfunctional amines, diepoxies, polyfunctional epoxies, diols, polyols, polyfunctional blocked isocyanate, polyfunctional aziridine, polyfunctional carbodiimide, and mixtures thereof.

According to a preferred embodiment, crosslinking agent c) may be selected from at least one of γ-glycidoxypropyltrimethoxysilane, 3-glycidoxypropylmethyldiethoxysilane, trimethoxypropylsilane, adipic acid dihydrazide, sebacic acid dihydrazide, valine dihydrazide, isophthalic dihydrazide, hexamethylenediamine, polyvinylalcohol, bisphenol A diglycidyl ether, 1,4-butanediol diglycidyl ether, blocked polyisocyanates (e.g. Desmodur® BL 3175 SN from Covestro), pentaerythritol tris(3-(1-aziridinyl)propionate), polycarbodiimide crosslinker (e.g. CARBODILITE™ V-02, CARBODILITE™ V-02-L2, CARBODILITE™ SV-02, CARBODILITE™ V-10, CARBODILITE™ SW-12G, CARBODILITE™ E-02, CARBODILITE™ E-03A, CARBODILITE™ E-05, CARBODILITE™ E-07s from Nisshinbo), and combinations thereof.

According to a more preferred embodiment, crosslinking agent c) may be selected from at least one of γ-glycidoxypropyltrimethoxysilane, 3-glycidoxypropylmethyldiethoxysilane, adipic acid dihydrazide, hexamethylenediamine, polyvinylalcohol, bisphenol A diglycidyl ether, 1,4-butanediol diglycidyl ether, blocked polyisocyanates (e.g. Desmodur® BL 3175 SN from Covestro), pentaerythritol tris(3-(1-aziridinyl)propionate), polycarbodiimide crosslinker (e.g. CARBODILITE™ V-02, CARBODILITE™ V-02-L2, CARBODILITE™ SV-02, CARBODILITE™ V-10, CARBODILITE™ SW-12G, CARBODILITE™ E-02, CARBODILITE™ E-03A, CARBODILITE™ E-05, CARBODILITE™ E-07s from Nisshinbo), and combinations thereof.

According to even more preferred preferred embodiment, crosslinking agent c) may be selected from at least one of γ-glycidoxypropyltrimethoxysilane, 3-glycidoxypropylmethyldiethoxysilane, adipic acid dihydrazide, hexamethylenediamine, polyvinylalcohol, polycarbodiimide crosslinker (e.g. CARBODILITE™ V-02, CARBODILITE™ V-02-L2, CARBODILITE™ SV-02, CARBODILITE™ V-10, CARBODILITE™ SW-12G, CARBODILITE™ E-02, CARBODILITE™ E-03A, CARBODILITE™ E-05, CARBODILITE™ E-07s from Nisshinbo), and combinations thereof.

The weight percentage of the crosslinking agent c) relative to the polymeric binder b) included in the composition for use as an electrode is preferably within the range of 0-40% by weight, and more preferably within the range of 0.01-20% by weight, and particularly preferably within 0.05-10% by weight of the polymeric binder b).

### Optional Components/Additives:

The compositions may also include the following optional components:
d) from 0-10% by weight of the polymeric binder of one or more wetting agents;
e) from 0-10% by weight of the polymeric binder of one or more dispersing agents;
f) from 0-10% by weight of the polymeric binder of one or more volatile organic compounds (VOC), and/or adhesion promoters, and/or coalescent agents;
g) from 0-200% by weight of polymeric binder of one or more rheology modifier additives; and
h) from 0-10% by weight of polymeric binder of one or more additives selected from anti-setting agents, surfactants, and mixtures thereof.

Surfactants and/or anti-settling agents may be added to the binder slurry composition at 0 to 10 parts, preferably from 0.1 to 10 parts, and more preferably 0.5 to 5 parts per 100 parts of water. These anti-settling agents or surfactants are added to the binder dispersion post-polymerization, generally to improve the shelf stability, and provide additional stabilization during slurry preparation. Some surfactant/anti-settling agent is also present in the composition remaining from the polymerization process. Useful anti-settling agents include, but are not limited to, ionic surfactants such as salts of alkyl sulfates, sulfonates, phosphates, phosphonates (such as sodium lauryl sulfate and ammonium lauryl sulfate) and salts of partially fluorinated alkyl sulfates, carboxylates, phosphates, phosphonates (such as those sold under the CAPSTONE brandname by DuPont), and non-ionic surfactants such as the TRITON X series (from Dow) and PLURONIC series (from BASF). In one embodiment, only anionic surfactants are used. It is preferred that no fluorinated surfactants are present in the composition, either residual surfactant from the polymerization process, or added post-polymerization in forming or concentrating an aqueous dispersion.

Wetting agents may be incorporated into the composition at from 0 to 5 parts, and preferably from 0 to 3 parts per 100 parts of water. Surfactants can serve as wetting agents, but wetting agents may also include non-surfactants. In some embodiments, the wetting agent can be an organic solvent. The presence of optional wetting agents permits uniform dispersion of powdery inorganic material(s) into aqueous dispersion of vinylidene fluoride polymer. Useful wetting agents include, but are not limited to, ionic and non-ionic surfactants such as the TRITON series (from Dow) and the PLURONIC series (from BASF), and organic liquids that are compatible with the aqueous dispersion, including but not limited to NMP, DMSO, and acetone.

Thickeners and rheology modifiers may be present in the fluoropolymer separator composition at from 0 to 10 parts, preferably from 0 to 5 parts per 100 parts of water. The addition of water-soluble thickener or rheology modifier to the above dispersion prevents or slows down the settling of inorganic powdery materials while providing appropriate slurry viscosity for a coating process. Useful thickeners include, but are not limited to the ACRYSOL series (from Dow Chemical); Rheotech series (from Coatex), Viscoatex series (from Coatex) partially neutralized poly (acrylic acid) or poly (methacrylic acid) such as CARBOPOL from Lubrizol or Viscodis 100N from Coatex; and carboxylated alkyl cellulose, such as carboxylated methyl cellulose (CMC). Adjustment of the formulation pH can improve the effectiveness of some of the thickeners. In addition to organic rheology modifiers, inorganic rheology modifiers can also be used alone or in combination. Useful inorganic rheology modifiers include, but are not limited to, inorganic rheology modifiers including but not limited to natural clays such as montmorillonite and bentonite, manmade clays such as laponite, and others such as silica, and talc.

An optional fugitive adhesion promoter helps to produce the interconnectivity needed in coatings formed from the composition of the invention. By “fugitive adhesion promoter” as used herein is meant an agent that increases the interconnectivity of the composition after coating. The fugitive adhesion promoter is then capable of being removed from the formed substrate generally by evaporation (for a chemical) or by dissipation (for added energy).

The fugitive adhesion promoter can be a chemical material, an energy source combined with pressure, or a combination, used at an effective amount to cause interconnectivity of the components of the aqueous composition during formation of the electrode. For chemical fugitive adhesion promoters, the composition contains 0 to 150 parts, preferably 0 to 100 parts, and more preferably from 0 to 30 parts, of one or more fugitive adhesion promoters per 100 parts of water. Preferably this is an organic liquid, that is soluble or miscible in water. This organic liquid acts as a plasticizer or coalescent agent acrylic particles, making them tacky and capable of acting as discrete adhesion points during the drying step. The binder particles are able to soften, flow and adhere to powdery materials during drying stage, resulting in electrodes with high connectivity that are non-reversible. In one embodiment a useful organic solvent or coalescent agents include, but are not limited to those in the table below.

| Coalescent | Company | VOC |
|---|---|---|
| Texanol ™ | Eastman | VOC |
| Optifilm ™ 400 | Eastman | Zero |
| Velate ™ 368 | Eastman | Low |
| Butyl Carbitol ™ | Dow | VOC |
| Dowanol ™ DPM | Dow | VOC |
| Citroflex ® 4 | Vertellus | Zero |
| | Specialties | |
| Benzoflex ™ 50 | Eastman | Zero |
| Loxanol ® CA5310 | BASF | Zero |

In the case of energy as the fugitive adhesion promoter, useful energy sources include, but are not limited to, heat, IR radiation, and radio frequency (RF). For heat alone, the temperature during the processing of the electrode should be about 20 to 50° C. above the glass transition point of the acrylic binder. When energy alone is used as the fugitive adhesion promoter, it is preferred that the heat is combined with pressure—such as a calendering step, for good interconnectivity and high adhesion to current collector and high cohesion within electrode.

### Applications:

The inventive composition for an electrode is suitable for use on a current collector within an electrical energy storage device containing a non-aqueous electrolyte, such as a secondary battery device. Such devices include an anode, a cathode, a separator between the anode and the cathode, and electrolyte.

An electrode, such as an anode, including the composition in dried form, for use as an electrode on a substrate (i.e., current collector) within an electrical energy storage device is disclosed. Such an electrode is preferably used as an anode and therefore most preferably the composition for use as an electrode disclosed herein is applied to a electroconductive substrate current collector made from copper.

Also provided is an electrical energy storage device selected from at least one of a non-aqueous-type battery, a capacitor, and a membrane electrode assembly that incorporates electrode comprising an electroconductive substrate coated on at least one surface with the composition for use as an electrode as disclosed herein, in dried form.

### Kits

The composition for use as an electrode on a current collector within an electrical energy storage device containing a non-aqueous electrolyte may be provided in the form of a kit. Thus, the at least one crosslinking agent c) may be combined with the polymeric binder b) to form a first component of the kit; and the at least one particulate electrode-forming material a) may be a second component of the kit.

Another embodiment of a kit is also provided. In this embodiment, the at least one particulate electrode-forming material a) may be the a first component of the kit; the polymeric binder b) may be a second component of the kit; and the at least one crosslinking agent c) may be a third component of the kit.

### EXAMPLES

Electrodes were calendared at very high pressure at room temperature to arrive at desired porosity. Porosity of the electrodes were back calculated from its expected (weight contribution of each component) and apparent densities where the apparent densities was obtained by measuring weight and volume of the electrode using micrometer and 5 decimal point balance.

Volume average particle size was measured by dynamic light scattering using a Nanotrac UPA150 from Microtrac.

### Example 1: Production of Binder

Into a 1 gallon reactor was introduced an initial charge composed of 800.00 g of deionized water and 0.78 g of Rhodacal® A-246 MBA. 211.35 g of 2-ethylhexyl acrylate, 230.19 g of styrene, 20.03 g of methyl methacrylate, 11.11 g of sodium 4-vinylbenzenesulfonate, 5.00 g of Silane A174, 25.00 g PEGMA (Mₙ=500 g/mol) were weighed out in a first glass beaker and mixed with 11.92 g of Rhodacal® A-246 MBA and 227.24 g of deionized water to prepare monomer pre-emulsion. 1.22 g of ammonium persulfate was weighed in a second glass beaker, dissolved in 15.00 g of deionized water to prepare initial initiator. 0.55 g of ammonium persulfate was dissolved in 32.00 g water in a third beaker to prepare delayed initiator. The contents of the reactor were heated to a temperature of 83±2° C. 37.09 g of the monomer pre-emulsion and the initial initiator were first introduced into the reactor. After the peak of the reaction exotherm, the remaining of the monomer pre-emulsion and the delayed initiator were feed into the reactor while keeping the reactor temperature 90±2° C. The delayed initiator solution was feed into the reactor over 260 mins. The monomer pre-emulsion was feed into the reactor over 4 stages. 176.18 g of the monomer pre-emulsion was feed into the reactor over 45 mins, followed by a 15 mins feed pause. Then the rest of the monomer pre-emulsion was feed into the reactor following the same feeding profile over three stages. After the completion of the delayed initiator feed over 260 mins, the contents in reactor was cooked for 30 mins before allowing the medium to cool to 70° C. During the 30 mins cook, a post oxidizer solution containing 2.88 g of 70% t-butyl hydroperoxide and 23.30 g of deionized water was prepared in a glass beaker. A post reducer solution containing 2.00 g of Bruggolite® FF6M and 45.00 g of deionized water was also prepared in a glass beaker. The post oxidizer and post reducer solution were then feed into the reactor over 45 mins after the 30 mins cook. The medium was allowed to cool, and filtered.

### Example 2: Production of Binder

The binder was produced in a similar manner as Example 1 except that monomers selection and ratio were different. The weight percentage of each monomer to total monomer used is listed in Table 1.

### Example 3: Production of Binder

The binder was produced in a similar manner as Example 1 except that monomers selection and ratio were different. The weight percentage of each monomer to total monomer used is listed in Table 1.

### Example 4: Production of Binder

The binder was produced in a similar manner as Example 1 except that monomers selection and ratio were different. The weight percentage of each monomer to total monomer used is listed in Table 1.

### Example 5: Production of Binder

The binder was produced in a similar manner as Example 1 except that monomers selection and ratio were different. The weight percentage of each monomer to total monomer used is listed in Table 1.

### Example 6: Production of Binder

Into a 1 gallon reactor was introduced an initial charge composed of 533.67 g of deionized water, 0.40 g of ammonium hydroxide and 1.40 g of Rhodacal® A-246 MBA. 458.32 g of 2-ethylhexyl acrylate, 346.56 g of styrene, 36.14 g of methyl methacrylate, 29.00 g of Sipomer® PAM600, 31.57 g of AAEM, 16.24 g of PEGMA (Mₙ=500 g/mol) were weighed out in a first glass beaker and mixed with 5.40 g of Rhodacal® A-246 MBA and 365.00 g of deionized water to prepare monomer pre-emulsion. 2.20 g of ammonium persulfate was weighed in a second glass beaker, dissolved in 15.00 g of deionized water to prepare initial initiator. 1 g of ammonium persulfate was dissolved in 32.00 g water in a third beaker to prepare delayed initiator. 4.00 g of ammonium hydroxide was dissolved in 29.00 g water in a fourth beaker to prepare third stream base feed. The contents of the reactor were heated to a temperature of 83±2° C. 64.41 g of the monomer pre-emulsion and the initial initiator were first introduced into the reactor. After the peak of the reaction exotherm, the remaining of the monomer pre-emulsion, the third stream base feed and the delayed initiator were feed into the reactor while keeping the reactor temperature 90±2° C. The delayed initiator solution and the third stream base were feed into the reactor over 260 mins. The monomer pre-emulsion was feed into the reactor over 4 stages. 305.96 g of the monomer pre-emulsion was feed into the reactor over 45 mins, followed by a 15 mins feed pause. Then the rest of the monomer pre-emulsion was feed into the reactor following the same feeding profile over three stages. After the completion of the delayed initiator feed over 260 mins, the contents in reactor was cooked for 30 mins before allowing the medium to cool to 70° C. During the 30 mins cook, a post oxidizer solution containing 3.90 g of 70% t-butyl hydroperoxide and 23.30 g of deionized water was prepared in a glass beaker. A post reducer solution containing 2.70 g of Bruggolite® FF6M and 45.00 g of deionized water was also prepared in a glass beaker. The post oxidizer and post reducer solution were then feed into the reactor over 75 mins after the 30 mins cook. The medium was allowed to cool, and filtered.

### Comparative Example 1: Production of Binder

Into a 1 gallon reactor was introduced an initial charge composed of 533.67 g of deionized water and 1.40 g of Rhodacal® A-246 MBA. 434.77 g of 2-ethylhexyl acrylate, 434.33 g of styrene, 36.14 g of methyl methacrylate were weighed out in a first glass beaker and mixed with 21.50 g of Rhodacal® A-246 MBA and 410.00 g of deionized water to prepare monomer pre-emulsion. 2.20 g of ammonium persulfate was weighed in a second glass beaker, dissolved in 15.00 g of deionized water to prepare initial initiator. 1.00 g of ammonium persulfate was dissolved in 32.00 g water in a third beaker to prepare delayed initiator. The contents of the reactor were heated to a temperature of 83±2° C. 66.84 g of the monomer pre-emulsion and the initial initiator were first introduced into the reactor. After the peak of the reaction exotherm, the remaining of the monomer pre-emulsion, the third stream base feed and the delayed initiator were feed into the reactor while keeping the reactor temperature 90±2° C. The delayed initiator solution and the third stream base were feed into the reactor over 260 mins. The monomer pre-emulsion was feed into the reactor over 4 stages. 317.48 g of the monomer pre-emulsion was feed into the reactor over 45 mins, followed by a 15 mins feed pause. Then the rest of the monomer pre-emulsion was feed into the reactor following the same feeding profile over three stages. After the completion of the delayed initiator feed over 260 mins, the contents in reactor was cooked for 30 mins before allowing the medium to cool to 70° C. During the 30 mins cook, a post oxidizer solution containing 2.60 g of 70% t-butyl hydroperoxide and 23.30 g of deionized water was prepared in a glass beaker. A post reducer solution containing 1.80 g of Bruggolite® FF6M and 45.00 g of deionized water was also prepared in a glass beaker. The post oxidizer and post reducer solution were then feed into the reactor over 75 mins after the 30 mins cook. The medium was allowed to cool, and filtered.

### Production of Negative Electrode Slurry

In a 125 mL polyethylene container of Thinky ARE-310, was placed seven 6.5 mm zirconia balls. 0.25 g of carbon black (Super P-Li from Timcal) plus 4.5 g of carboxymethyl cellulose (CMC) solution (BVH9 from Ashland Chemicals) at 1.5% solids in water and 9.1 g of graphite (GHDR 15-4 from Imerys) plus 2.5 gr of silicon (amorphous silicon from NanoAmor) were added and mixed at 2000 rpm for 2 minutes. Then, 1.0 g of CMC solution was successively added and mix at 2000 rpm for 2 minutes, followed by another CMC solution addition and mixing to reach 10.0 g total CMC solution addition. Then 2.5 g of Examples above at 20% solids by weight was added and mixed for 2 minutes at 2000 rpm for two times.

Electrodes Fabrication & Testing:

The slurries prepared above were cast on to copper foil with a wet thickness of about 110 μm and placed in to a convection oven for 30 min at 120′° C. Then, the electrode was calendared to reach porosity of about 30% by volume. Adhesion measurements were performed with an Instron using 180 degree peel at 50 mm/min crosshead speed using 1 inch wide electrode specimens according to ASTM-D903 (2017).

TABLE 1
Polymer binder compositions by monomer weight percentage, latex
particle size and the corresponding electrodes peel adhesions.

| | Exp. 1 | Exp. 2 | Exp. 3 | Exp. 4 | Exp. 5 | Exp. 6 | CE. 1 |
|---|---|---|---|---|---|---|---|
| Sty i) | 46 | 45.9 | 46 | 46 | 48 | 38.3 | 48 |
| 2EHA i) | 42 | 43 | 43 | 43 | 43 | 50.6 | 48 |
| MMA i) | 4 | 4 | 4 | 4 | 4 | 4 | 4 |
| PEGMA ii) | 5 | 5 | 5 | 5 | 5 | 1.8 | |
| SSS iii) | 2 | 2 | | 2 | | | |
| PAM4000 iii) | | | 2 | | | | |
| PAM600 iii) | | | | | | 1.8 | |
| DVB iv) | | 0.1 | | | | | |
| AAEM v) | | | | | | 3.5 | |
| A174 v)/vi) | 1 | | | | | | |
| Particle size | 94 | 102 | 114 | 97 | 110 | 115 | 126 |
| (nm) | | | | | | | |
| Electrode | 31 | 18 | 22 | 19 | 18 | 41 | NA |
| peel adhesion | | | | | | | |
| (N/m) | | | | | | | |

Abbreviations:
2EHA = 2-ethylhexyl acrylate i)
A174 = 3-(triethoxysilyl)propyl methacrylate v)/vi)
AAEM = acetoacetoxyethyl methacrylate v)
CMC = carboxymethylcellulose
DAAM = diacetone acrylamide v)
DVB = divinylbenzene iv)
MMA = methyl methacrylate i)
PAA = polyacrylic acid
PAM 4000 = Sipomer ® PAM 4000 (phosphate ester of ethyl methacrylate) iii)
PAM 600 = Sipomer ® PAM 600 (phosphate ester of polypropylene glycol monomethacrylate) iii)
PEGMA = poly(ethylene glycol) methyl ether methacrylate ii)
SBR = styrene butadiene rubber
SSS = sodium 4-vinylbenzenesulfonate iii)
Sty = styrene i)

All the Examples in Table 1 were evaluated in a negative electrode formulation to compare their performance in slurry preparation and electrode adhesion. In the slurry preparation step, stable slurries were prepared with all the inventive Examples 1-6. However, slurry preparation with the Comparative Example 1 was unsuccessful. Coagulated solid was observed when preparing slurry with Comparative Example 1. A direct comparison between Example 5 and Comparative Example 1 in the slurry preparation demonstrates improvement provided by the PEGMA monomer (monomer ii).

Table 1 lists peel adhesion of electrode prepared with inventive Examples 1-6. Peel adhesion is a measure of binder's binding ability in electrode. High peel adhesion is preferred for electrode processing and battery cycling. 10 N/m or larger is generally preferred for electrode processing. Peel adhesion of all inventive Examples are larger than 10 N/m. Peel adhesion for Comparative Example 1 is not available due to unstable slurry. In addition, inventive Examples 1, 3 and 6 with additional functional monomers show improved peel adhesion as compared to the inventive Example 5. These functional monomers iii), v) and vi) further improve electrodes peel adhesion, which is beneficial for electrode processing and battery cycling.

Although the invention is illustrated and described herein with reference to specific embodiments, the invention is not intended to be limited to the details shown. Rather, various modifications may be made in the details within the scope and range of equivalents of the claims and without departing from the invention.

1. A composition for use as an electrode on a current collector within an energy storage device containing a non-aqueous electrolyte, the composition comprising:
a) at least one particulate electrode-forming material;
b) a polymeric binder, comprising, as polymerized monomers:
i) 10-99% by weight of the polymeric binder of at least one non-ionic monoethylenically unsaturated monomer;
ii) 0.5-42% by weight of the polymeric binder of at least one oxyalkylated monomer with ethylenic unsaturation and terminated by hydrogen or an aryl or alkyl chain, having the following formula: 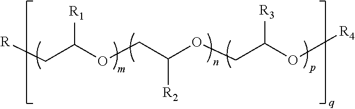
wherein:
m, n and p represent a number of alkylene oxide units of between 0 and 150, wherein m+n+p≥1,
q represents a whole number at least equal to 1,
R₁, R₂, and R₃ represent either H, CH₃ or CH₂CH₃, and R₁, R₂, and R₃ can be the same or different,
R₄ represents a terminal group, which can be a hydrogen, alkyl chain with 1-60 carbon atoms or aryl chain with 5-60 carbon atoms,
R represents a group including at least one polymerizable olefinic unsaturation, and mixtures thereof;
iii) 0-50% by weight of the polymeric binder of at least one ethylenically unsaturated ionic monomer comprising at least one functional group selected from carboxylate, sulfonate, sulfate, phosphate, phosphonate, and/or acid, and/or salt, and/or anhydride forms thereof, and combinations thereof;
iv) 0-10% by weight of the polymeric binder of at least one monomer comprising at least two ethylenic unsaturations;
v) 0-10% by weight of the polymeric binder of at least one ethylenically unsaturated monomer comprising at least one functional group selected from N-methylol amide, N-alkylol amide, hydroxyl group, epoxy, silane, keto, and combinations thereof; and
vi) 0-30% by weight of the polymeric binder of at least one ethylenically unsaturated monomer comprising at least one functional group selected from silane, ureido, amine, hydroxyl group, and combinations thereof;
wherein the polymeric binder b) has a Tg of 55° C. or less and/or a minimum film forming temperature of 25° C. or less;
and wherein the total of components b) i) through b) vi) add up to 100% by weight of polymeric binder b);
c) from 0-40% by weight of the polymeric binder of at least one crosslinking agent capable of reacting with the polymeric binder b);
d) from 0-10% by weight of the polymeric binder of one or more wetting agents;
e) from 0-10% by weight of the polymeric binder of one or more dispersing agents;
f) from 0-10% by weight of the polymeric binder of one or more volatile organic compounds (VOC), and/or adhesion promoters, and/or coalescent agents;
g) from 0-200% by weight of polymeric binder of one or more rheology modifier additives; and
h) from 0-10% by weight of polymeric binder of one or more additives selected from anti-setting agents, surfactants, and mixtures thereof.

2. The composition of claim 1, wherein the monomer ii) comprises at least one of polyalkylene glycol mono(meth)acrylate and its hydroxyl group functionalized derivatives, polyalkylene glycol monoallyl ether and its hydroxyl group functionalized derivatives, polyalkylene glycol monovinyl ether and its hydroxyl group functionalized derivatives, and combinations thereof.

3. The composition of claim 1, wherein the at least one crosslinking agent c) comprises at least one of epoxy, amine, alcohol, blocked isocyanate, carbodiimide, polyfunctional aziridine, silane, and mixtures thereof.

4. The composition of claim 1, wherein the polymeric binder b) has a volume average particle size of from 30-500 nm, or comprises a mix of various particle sizes from 30 to 500 nm.

5. The composition of claim 1, wherein the polymeric binder b) has a number average molecular weight of 1000 gm/mol or more.

6. The composition of claim 1, wherein the monomer i) comprises at least one of C1 to C12 alkyl (meth)acrylate, styrene and derivatives thereof, vinyl acetate, vinyl versatate, (meth)acrylamide, (meth)acrylonitrile and derivatives thereof, diisobutylene, vinylpyrrolidone, vinylcaprolactam, and mixtures thereof.

7. The composition of claim 1, wherein the monomer iii) comprises at least one of (meth) acrylic acid, 2-carboxyethyl acrylate, 2-polycarboxy ethyl acrylate, mono-ester of itaconic acid, maleic acid, fumaric acid, crotonic acid, itaconic acid, 2-acrylamide-2-methylpropane sulfonic acid, 4-styrenesulfonic acid, vinylsulfonic acid, 2-sulfoethyl methacrylate, phosphate esters of polyalkylene glycol mono(meth)acrylate, polyalkylene glycol allyl ether phosphates, vinylphosphonic acid, 2-(methacryloyloxy)ethyl phosphonic acid, and/or acid and/or salt and/or anhydride forms thereof, and mixtures thereof.

8. The composition of claim 1, wherein the monomer iv) comprises at least one of allylic ethers obtained from polyols; acrylic or methacrylic esters obtained from polyols; divinyl naphthalene, trivinylbenzene, 1,2,4-trivinylcyclohexane, triallyl pentaerythritol, diallyl pentaerythritol, diallyl sucrose, trimethylolpropane diallyl ether, 1,6-hexanediol di(meth)acrylate, allyl (meth)acrylate, diallyl itaconate, diallyl fumarate, diallyl maleate, butanediol dimethacrylate, ethylene di(meth)acrylate, poly(ethylene glycol) di(meth)acrylate, trimethylolpropane tri(meth)acrylate, methylenebis(meth)acrylamide, triallylcyanurates, diallyl phthalate, divinylbenzene, and mixtures thereof.

9. The composition of claim 1, wherein the monomer v) comprises at least one of N-alkylol(meth)acrylamide, vinyl glycidyl ether, allyl glycidyl ether, glycidyl (meth)acrylate, diacetone acrylamide, acetoacetoxyethyl methacrylate, (meth)acryloxyalkyltrialkoxysilanes, vinyltrialkoxysilanes, and mixtures thereof.

10. The composition of claim 1, wherein the monomer vi) comprises at least one of (meth)acryloxyalkyltrialkoxysilanes, vinyltrialkoxysilanes, (meth)acrylate ester of substituted urea, (meth)acrylamide of substituted urea, allyl ether of substituted urea, aminoalkyl (meth)acrylate, hydroxyalkyl (meth)acrylate, and mixtures thereof.

11. The composition of claim 1, wherein the a) at least one particulate electrode-forming material comprises one or more materials selected from furnace black, acetylene black, Ketjen carbon black, carbon nanotubes (CNTs), synthetic graphite, natural graphite, hard carbon, activated soft carbon, carbon black, graphene, mesoporous carbon, amorphous silicon, semi-crystalline silicon, silicon oxides, silicon nanowires, tin, tin oxides, germanium, lithium titanate, and mixtures or composites thereof.

12. An electrode comprising an electroconductive substrate coated on at least one surface with the composition of claim 1.

13. A device comprising the electrode of claim 12, selected from the group consisting of a non-aqueous-type battery, a capacitor, and a membrane electrode assembly.

14. A kit comprising the electrode forming composition of claim 1 wherein:
the at least one crosslinking agent c) is combined with the polymeric binder b) to form a first component of the kit; and
wherein the at least one particulate electrode-forming material a) comprises a second component of the kit.

15. A kit comprising the composition of claim 1 wherein:
the a) at least one particulate electrode-forming material comprises a first component of the kit;
the polymeric binder b) comprises a second component of the kit; and the at least one crosslinking agent c) comprises a third component of the kit.
